(19) United States
(12) Patent Application Publication
(10) Pub. No.: US 2018/0266176 A1
(43) Pub. Date: Sep. 20, 2018

(54) Motorized Roll-Up Window Shade

(71) Applicants: David R. Hall, Provo, UT (US); Emily Brimhall, Alpine, UT (US); Austin Carlson, Provo, UT (US); Jedediah Knight, Provo, UT (US)

(72) Inventors: David R. Hall, Provo, UT (US); Emily Brimhall, Alpine, UT (US); Austin Carlson, Provo, UT (US); Jedediah Knight, Provo, UT (US)

(21) Appl. No.: 15/458,453

(22) Filed: Mar. 14, 2017

(51) Int. Cl. E06B 9/42; E06B 9/72; E06B 9/44

(52) U.S. Cl. CPC E06B 9/42; E06B 9/44; E06B 9/72

(57) ABSTRACT

Motorized window coverings are described herein. Various embodiments may include roll-up window shades, vertical blind slats, and/or horizontal blind slats. In one example, a motorized roll-up window shade is described. The shade includes a tube, a flexible panel, a fixed bracket, a rotatable bracket, bearings, a motor, and one or more batteries. The tube may have a longitudinal axis perpendicular to a transverse axis. The fixed bracket may include a first segment and a second segment connected to the tube and movably connected to the first segment. The rotatable bracket may include an articulating joint and may rotate the tube along the transverse axis. The bearings may enable rotation of the tube along the longitudinal axis. The motor and batteries may be disposed within the tube. The fixed bracket may include an opening through which the batteries may be accessed.

### TECHNICAL FIELD

This invention relates generally to the field of window coverings and more specifically to motorized window coverings.

### BACKGROUND

As the Internet of Things grows, Window blinds and shades are increasingly motorized. This presents new problems in the design of such devices. One such problem includes powering the motor. Some solutions include using batteries. Some batteries are disposed outside the shade, such as outside the headrail or tube. However, this presents aesthetic problems, as well as problems exposing the battery to environmental conditions. Some manufacturers have placed batteries inside the headrail or tube. Unfortunately, access to the batteries is still a challenge. In some cases, the window blind or shade must be removed to replace the batteries. In some roller shade cases, the shade must be completely unrolled and the tube exposed to remove and replace the batteries. This can be problematic if the batteries are completely dead, and can be inconvenient whether the batteries are dead or not. Thus, there is still room for improvement.

### SUMMARY OF THE INVENTION

Motorized window coverings are described herein that address at least some of the problems and/or inconveniences described above in the Background. Various embodiments may include roll-up window shades, vertical blind slats, and/or horizontal blind slats. In one example, a motorized roll-up window shade is described. The shade includes a tube, a flexible panel, a fixed bracket, a rotatable bracket, bearings, a motor, and one or more batteries. The tube may have a longitudinal axis perpendicular to a transverse axis. The flexible panel may be connected to the tube and may roll on and off the tube. The fixed bracket may include a first segment that affixes the fixed bracket to a mounting surface and a second segment connected to the tube and movably connected to the first segment. The rotatable bracket may include an articulating joint and may extend into the tube at an opposite end of the tube from the fixed bracket. The rotatable bracket may rotate the tube along the transverse axis. The bearings may be disposed between the second segment and the tube and between the rotatable bracket and the tube enabling rotation of the tube along the longitudinal axis. The motor may be disposed within the tube and supported by the fixed bracket. The batteries may also be disposed within the tube and supported by the fixed bracket. The fixed bracket may include an opening through which the batteries may be accessed.

### BRIEF DESCRIPTION OF THE DRAWINGS

A more particular description of the thermoforming apparatus summarized above is made below by reference to specific embodiments. Several embodiments are depicted in drawings included with this application, in which:

FIG. 1 depicts an embodiment of a roll-up window shade;

FIG. 2 depicts an embodiment of a roll-up window shade with overlaid axes;

FIG. 3 depicts an embodiment of a roll-up window shade, excluding the flexible panel;

FIGS. 4A-B depict front and side views, respectively, of a roll-up window shade;

FIGS. 5A-C depict cross-sectional portions of a roll-up window shade sub-divided and zoomed-in to show detail;

FIGS. 6A-B depict two views of an alternative embodiment of an extendable bracket that supports a tube of a roll-up window shade;

FIG. 7 depicts two views of another alternative embodiment of an extendable bracket that supports a tube of a roll-up window shade;

FIG. 8 depicts a cross-sectional view of an alternative embodiment of a rotatable bracket that supports a tube of a roll-up window shade; and

FIG. 9 depicts a battery sleeve partially removed from a tube of a roll-up window shade.

### DETAILED DESCRIPTION

A detailed description of embodiments of a motorized window shade is provided below by example, with reference to embodiments in the appended figures. Those of skill in the art will recognize that the components of the invention as described by example in the figures below could be arranged and designed in a wide variety of different configurations. Thus, the detailed description of the embodiments in the figures is merely representative of embodiments of the invention, and is not intended to limit the scope of the invention as claimed.

The descriptions of the various embodiments include, in some cases, references to elements described with regard to other embodiments. Such references are provided for convenience to the reader, and to provide efficient description and enablement of each embodiment, and are not intended to limit the elements incorporated from other embodiments to only the features described with regard to the other embodiments. Rather, each embodiment is distinct from each other embodiment. Despite this, the described embodiments do not form an exhaustive list of all potential embodiments of the claimed invention; various combinations of the described embodiments are also envisioned, and are inherent from the descriptions of the embodiments below. Additionally, embodiments not described below that meet the limitations of the appended claims are also envisioned, as is recognized by those of skill in the art.

Various motorized window covering embodiments are described herein. Such embodiments may include roll-up window shades, vertical blind slats, and/or horizontal blind slats. Embodiments may include a support segment, a covering segment, a motor, one or more batteries, a rotatable bracket, and/or a fixed bracket. The motor and/or batteries may be disposed within the support segment. The support segment may be structured to allow for exchanging of the batteries without removing the window covering assembly from the window. The support segment may further be structured to allow for exchanging of the batteries by only removing a small covering over the batteries. In window blind embodiments, the covering may include a minor segment of a headrail covering. In roll-up shade embodiments, the covering may include a cap over an opening at an end of a tube of the roll-up shade. In some embodiments, no segment of the support structure is removed in exchanging the batteries.

The support segment may include one or more of a headrail, a tilt rod, and a roller tube. For example, the window covering may include a set of venetian blinds. In such embodiments, the support segment may include a tilt rod disposed within a headrail. The tilt rod may be connected to blind slats via strings. As another example, the window covering may include a roll-up window shade. In such embodiments, the support segment may include a tube that rolls-up and unrolls a flexible panel. The support segment may include a longitudinal axis and a transverse axis perpendicular to the longitudinal axis. As used herein, longitudinal may refer to an axis along a longest length of the object being referred to, and transverse may refer to an axis perpendicular to the longitudinal axis.

The support segment may be mounted to one or more surfaces, such as around or within a window frame, by one or more mounting brackets. One such mounting bracket may include an extendable bracket. The extendable bracket may be connected to the support segment and may include a first segment that affixes the extendable bracket to a mounting surface and a second segment connected to the support segment and extendably connected to the first segment. The extendable bracket may be disposed inside and/or outside the support segment. In some embodiments, the extendable bracket may support the motor and/or batteries. In such embodiments, the extendable bracket may be disposed within the support segment, and may extend from the support segment to mount the support segment to a mounting surface.

The extendable bracket may include an extension mechanism. The second segment may be connected to the first segment by the extension mechanism. The extension mechanism may limit a range of motion of the support segment along the transverse axis. In some embodiments, the extension mechanism may include a telescoping rod assembly. In other embodiments, the extension mechanism may include a track-and-runner set, wherein the track may align parallel to the transverse axis. For example, the first segment may include a track, and the second segment may include one or more runners disposed within the track. The track may remain fixed with respect to the mounting surface while the runners move with the support segment in the track. In some embodiments, the track may include a hinge. The track may fold out to allow the second segment to move along the track, and may fold back to prevent motion of the second segment with respect to the first segment. The track may include a stop that limits a range of motion of the support segment along the transverse axis.

A securing mechanism may be incorporated into the extendable bracket that prevents motion of the second segment with respect to the first segment. For example, in some embodiments, the securing mechanism may be comprised of the track in the folded-back position. In some embodiments, the securing mechanism may be comprised of one or more clips and/or snaps that fixedly connect the first segment to the second segment. In some embodiments, the securing mechanism may be comprised of strips of hook-and-loop fabric, such as Velcro. In some embodiments, the securing mechanism may be comprised of hydraulic tension in the telescoping rod assembly that resists a change in the length of the assembly.

The extendable bracket may include an opening through which the batteries may be accessed. For example, the opening may be formed in the second segment. In various embodiments, a removable cap may be disposed over the opening, with the batteries disposed between the cap and the motor. The cap may provide tension, such as by an incorporated spring, that maintains electrical contact between the batteries and the motor. In some embodiments, the cap may be connected to the second segment.

Another mounting bracket may include a rotatable bracket that enables rotation of the support segment about a pivot axis passing through the rotatable bracket. The rotatable bracket may rotate the support segment along the transverse axis. The rotatable bracket may include an articulating joint. Some embodiments of the window covering may include both the extendable bracket and the rotatable bracket. In such embodiments, the rotatable bracket may be disposed at an opposite end of the support segment from the extendable bracket. The rotatable bracket, or the combination of the rotatable bracket and the extendable bracket, may enable rotation of the support segment along the transverse axis. This may enable simpler access to the batteries compared with previous solutions because the window covering may not need to be removed from the window to replace the batteries. This may also improve aesthetics of solutions with batteries outside the support segment and/or separate from the window covering. Additionally, this may allow access to the batteries even when the batteries are dead and without removing and/or unraveling significant portions of the window covering.

The articulating joint may enable rotation of the tube along the transverse axis. The articulating joint may, therefore, be disposed between a portion of the rotatable bracket that mounts to a mounting surface and a portion that connects to the support segment. The articulating joint may include one or more of various hinges. For example, the articulating joint may include a barrel hinge. The barrel hinge may have a longitudinal axis perpendicular to the support segment's longitudinal and transverse axes. In some embodiments, the articulating joint may be spherical, and may enable rotation of the support segment along the support segment's transverse axis and along an axis perpendicular to the support segment's transverse and longitudinal axes. For example, the articulating joint may include a spherical segment disposed in a spherical housing. The spherical segment may include a first arm extending from the spherical segment and connected to the support segment. The spherical segment may also include a second arm. The spherical housing may include an opening through which at least a part of the spherical segment and the first arm extends, and a hollow portion within which the second arm is disposed. Rotation of the spherical segment within the housing may cause the second arm to butt against an interior surface of the hollow arm, thereby preventing further rotation of the joint in that direction. The hollow arm may extend from the spherical housing to a portion of the rotatable bracket that mounts to a mounting surface.

The rotatable bracket may include a mounting segment that mounts the rotatable bracket to a mounting surface. The mounting segment may have a length equal to at least twice a transverse length of the support segment, such as a diameter of a tube. In various embodiments, the length of the mounting segment may range from 1.5 times the transverse length of the support segment to 5 times the transverse length of the support segment. An arm may extend from the mounting segment to the articulating joint, and may include a buttress aligned parallel to a direction of the force of gravity on the support segment. The buttress may provide additional support for the support segment. Alternatively, the articulating joint may be connected directly to the mounting segment.

As described above, in some embodiments, the support segment may include a headrail. The headrail may include a tilt rod and housing around the tilt rod. The housing may include a decorative exterior, and may provide structural support for internal components, such as the tilt rod, the motor, and the batteries. The batteries may be accessed via the extendable-bracket-end of the headrail. The second segment of the extendable bracket may be fixed to the headrail, and the first segment may be fixed to the mounting surface. The headrail may also be connected to, and supported by, the rotatable bracket. The headrail may be disposed in a window frame. A user may change the batteries by rotating the headrail about the articulating joint to a stop point set by the extendable bracket or the rotatable bracket.

In some embodiments, the support segment may include a roller tube. The roller tube may support a flexible panel that shades a corresponding window. The flexible panel may be connected to the tube, and wind onto and off the tube by rotation of the tube about the longitudinal axis. Bearings may be disposed between the second segment of the extendable bracket and the tube and between the rotatable bracket and the tube that enable rotation of the tube along the longitudinal axis. For example, the tube may include a groove along an interior circumference of the tube. The extendable bracket, the rotatable bracket, or both, may also/alternatively include a groove along an exterior circumference. The bearings may be spherical metal balls, and may be disposed in the interior circumference groove and the exterior circumference groove between the tube and the brackets. Alternatively, the brackets may extend over the ends of the tubes, with grooves along interior circumferences of the brackets and along an exterior circumference of the tube.

The brackets may extend into the tube. For example, the second segment of the rotatable bracket may extend into the tube to support the motor and/or batteries. This may allow the motor and/or batteries to be fixed while rotating the tube to wind the flexible panel onto, or off of, the tube.

In various roll-up window blind embodiments, various mechanisms may be employed to maintain alignment of the flexible panel on the tube as the panel is wound onto the tube. For example, the tube may include one or more flanges at one or more ends of the tube. The flanges may align the flexible panel on the tube as the flexible panel is wound onto the tube. Additionally or alternatively, the flexible panel may include one or more magnets along one or more edges of the panel. The magnets may align the flexible panel as the flexible panel is wound onto the tube.

As described above regarding various embodiments, the covering segment of the window covering may vary depending on the type of window covering. For example, in roll-up window blind embodiments, the window covering may include the flexible panel mentioned above. The flexible panel may be comprised of one or more flexible plastics, fabrics, or metals. The flexible panel may be partially transparent, or may be completely opaque. In window blind embodiments, the covering segment may include one or more window blind slats. The slats may be aligned vertically or horizontally, and may be constructed one or more materials include plastic (such as vinyl) or metal (such as aluminum). The slats may be flexible or rigid, and may be formed in one or more of a variety of shapes.

The motor may include various types of motors, include AC and/or DC, brushless, and induction, to name a few. In battery-powered AC embodiments, the motor may include an inverter. The motor may also include a stator, a rotor, and a transmission. In roll-up window blind embodiments, the transmission may include a set of planetary gears that engage an interior surface of the tube to rotate the tube. In blind slat embodiments, the transmission may include a set of gears that convert high RPMs of the motor to high torque to tilt and/or raise the slats.

The batteries may include various types of batteries, including rechargeable Li-Ion batteries and/or off-the shelf alkaline batteries. The batteries may be disposed in a removable sleeve that partially or completely encloses the batteries. The sleeve may be movably or fixedly connected to the extendable bracket. For example, in one embodiment, the sleeve includes a track formed in the sleeve and the second segment of the extendable bracket includes a fixed runner corresponding to, and disposed in, the track. The track may be slid across the runner, allowing a user to remove the sleeve from the support segment, such as from inside a tube. The sleeve may additionally/alternatively include a stop mechanism that prevents the sleeve from being completely removed from the support segment.

General features of various window covering embodiments are described above. Below, specific embodiments of window coverings are described with regard to the appended FIGs. that incorporate the general features described above. Those of skill in the art recognize the depicted and described specific embodiments are generalizable based on the description above, and that the features described above may be embodied in ways not depicted in the FIGs. or described below regarding the specific embodiments. The specific embodiments described below are provided for convenience and to ease understanding of the general features described above, but are not intended to limit the general features described above.

The specifically-depicted embodiments include a motorized roll-up window shade. The shade includes a tube, a flexible panel, a fixed bracket, a rotatable bracket, bearings, a motor, and one or more batteries. The tube has a longitudinal axis perpendicular to a transverse axis. The flexible panel is connected to the tube and winds on and off the tube. The fixed bracket includes a first segment that affixes the fixed bracket to a mounting surface and a second segment connected to the tube and movably connected to the first segment. The rotatable bracket includes an articulating joint and extends into the tube at an opposite end of the tube from the fixed bracket. The rotatable bracket rotates the tube along the transverse axis. The bearings are disposed between the second segment and the tube and between the rotatable bracket and the tube enabling rotation of the tube along the longitudinal axis. The motor is disposed within the tube and supported by the fixed bracket. The batteries are also disposed within the tube and supported by the fixed bracket. The fixed bracket includes an opening through which the batteries may be accessed.

The extendable bracket includes a securing mechanism that prevents motion of the second segment with respect to the first segment. The second segment is connected to the first segment by a telescoping rod in one embodiment. The telescoping rod limits a range of rotation of the tube along the transverse axis. The first segment includes a track in some embodiments, and the second segment includes one or more runners disposed within the track. In one embodiment, the track includes a hinge, and folds out to allow the second segment to move along the track, and fold back to prevent motion of the second segment with respect to the first segment. In one embodiment, the second segment aligns parallel to the transverse axis. In one embodiment, the track includes a stop that limits a range of motion of the tube along the transverse axis.

The articulating joint includes, in some embodiments, a hinge. In one embodiment, the hinge is a barrel hinge having a longitudinal axis perpendicular to the tube's longitudinal and transverse axes. In some embodiments, the articulating joint is spherical and enables rotation of the tube along the tube's transverse axis and along an axis perpendicular to the tube's longitudinal and transverse axes. In one embodiment, the articulating joint includes a spherical segment disposed in a spherical housing. The spherical segment includes a first arm extending from the spherical segment and connected to the tube, and a second arm. The spherical housing includes an opening through which at least a part of the spherical segment and the first arm extends, and a hollow arm within which the second arm is disposed.

In one embodiment, a removable cap is connected to the second segment over the opening. The batteries are disposed between the cap and the motor.

In some embodiments, a removable sleeve partially or completely encloses the batteries within the tube. In one embodiment, the sleeve includes a track and the second segment includes a fixed runner corresponding to the track. In another embodiment, the sleeve includes a stop that prevents to the sleeve from being completely removed from the tube.

In one embodiment, the rotatable bracket includes a mounting segment that mounts the rotatable bracket to a mounting surface. The mounting segment has a length equal to at least twice a diameter of the tube.

In one embodiment, the tube includes a groove along an interior circumference of the tube. The extendable bracket, the rotatable bracket, or both, include a groove along an exterior circumference. The bearings are disposed in the interior circumference groove and the exterior circumference groove.

In one embodiment, the tube includes one or more flanges at one or more ends of the tube. The flanges align the flexible panel on the tube as the flexible panel is wound onto the tube. In another embodiment, the flexible panel includes one or more magnets along one or more edges of the panel. The magnets align the flexible panel as the flexible panel is wound onto the tube.

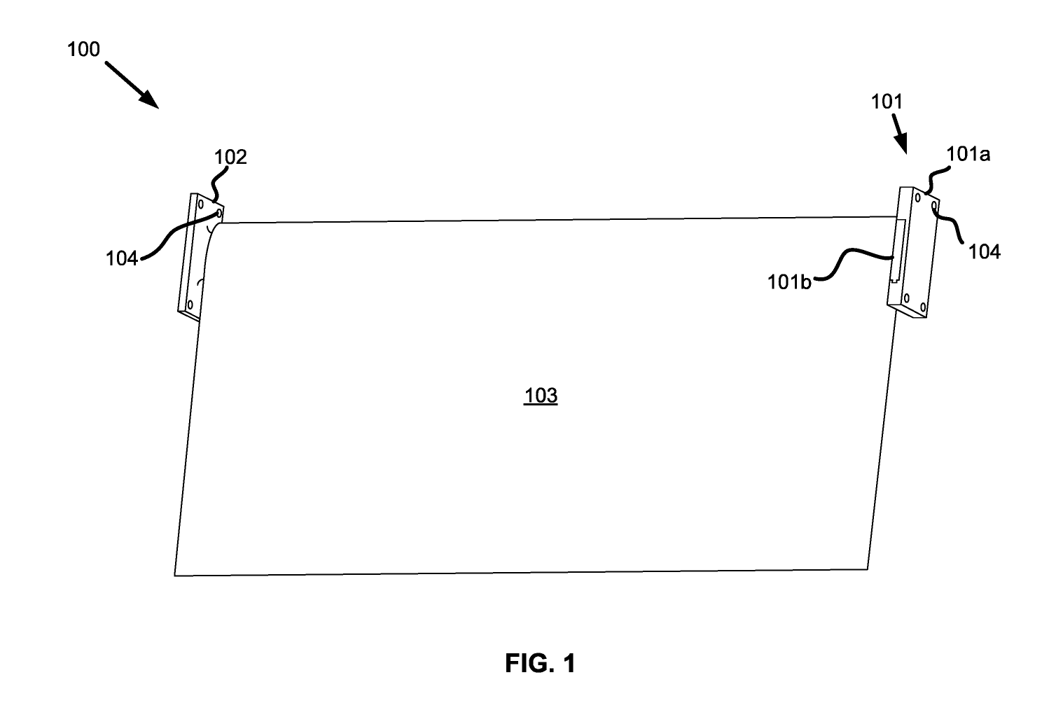

FIG. 1 depicts an embodiment of a roll-up window shade. The window shade 100 includes an extendable bracket 101 with a first segment 101a and a second segment 101b, a rotatable bracket 102, and a flexible panel 103. The brackets include openings 104 that enable mounting of the brackets to a mounting surface, such as a wall and/or window frame. For example, screws may be passed through the openings. The flexible panel is wound around a tube that is supported by the brackets. Bearings are disposed between the tube and the brackets to enable longitudinal rotation of the tube. A motor and a set of batteries are disposed within the tube.

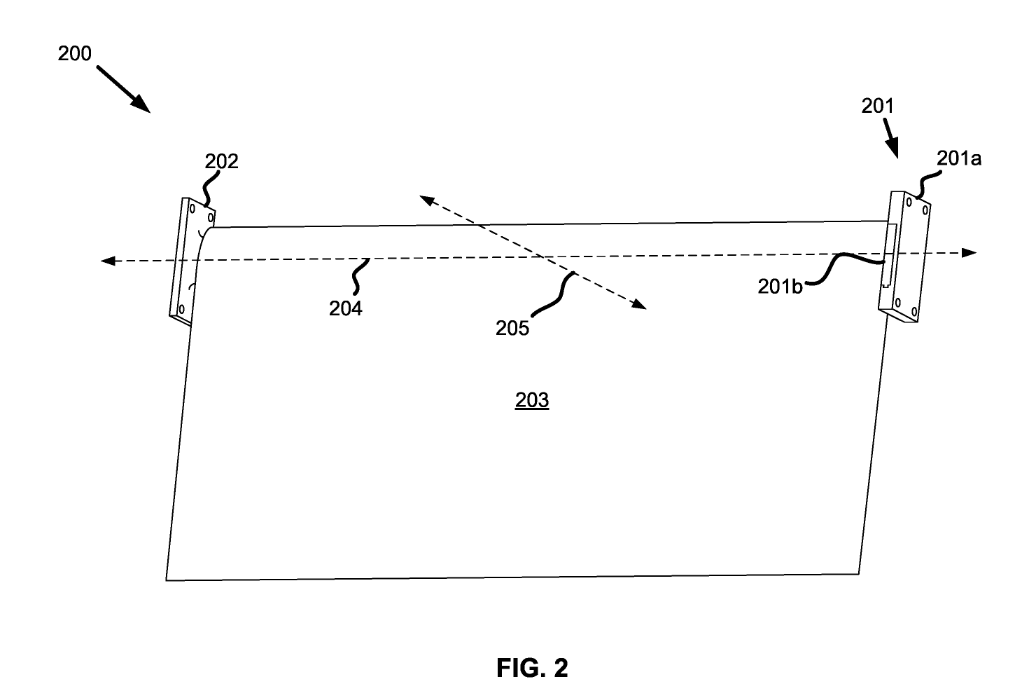

FIG. 2 depicts an embodiment of a roll-up window shade with overlaid axes. The window shade 200 includes an extendable bracket 201 with a first segment 201a and a second segment 201b, a rotatable bracket 202, a flexible panel 203, a longitudinal axis 204, and a transverse axis 205. Bearings disposed between the brackets and a tube around which the flexible panel is wound enable rotation of the tube about the longitudinal axis, and thus winding and unwinding of the flexible panel. The tube also rotates about a pivot point formed by the rotatable bracket and along the transverse axis. Rotation along the transverse axis causes the second segment to extend from the first segment, allowing a user to access internal components of the tube, such as batteries and a motor.

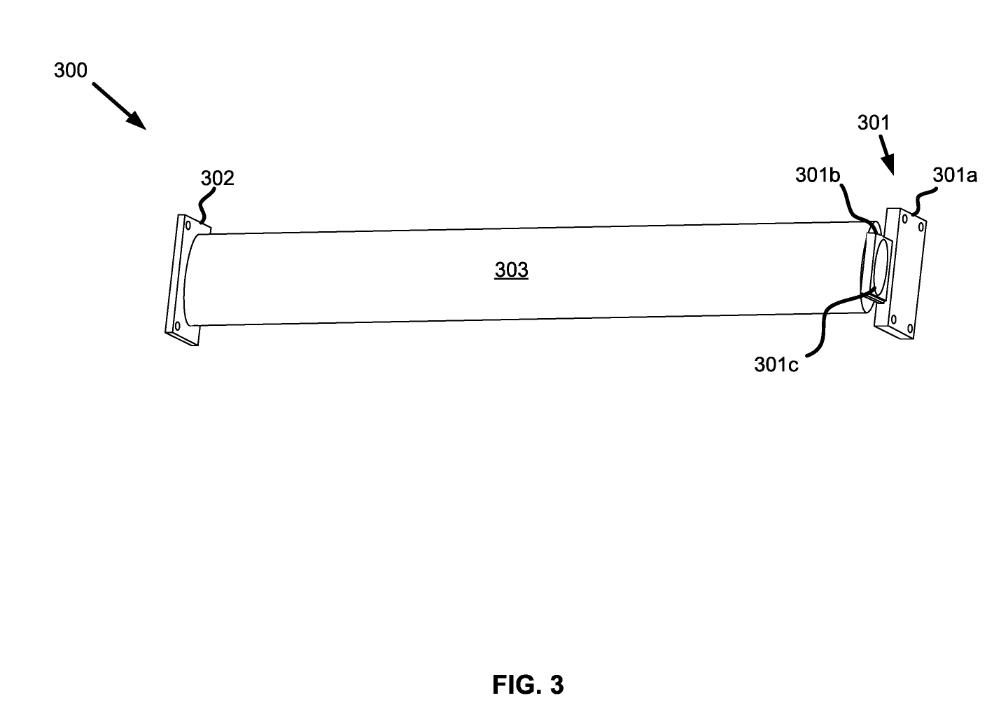

FIG. 3 depicts an embodiment of a roll-up window shade, excluding the flexible panel. The window shade 300 includes an extendable bracket 301 with a first segment 301a, second segment 301b and an opening 301c in the second segment, a rotatable bracket 302, and a tube 303. A portion of the second segment is disposed in the tube, and a portion out. The portion in the tube enables rotation of the tube, provides structural support for the tube, and provides support for internal components of the tube, such as a motor and batteries. Similarly, a portion of the rotatable bracket extends into the tube to provide structural support for the tube and enable rotation of the tube. As shown, the second segment is extended from the first segment, exposing the opening, and allowing access to the batteries and motor.

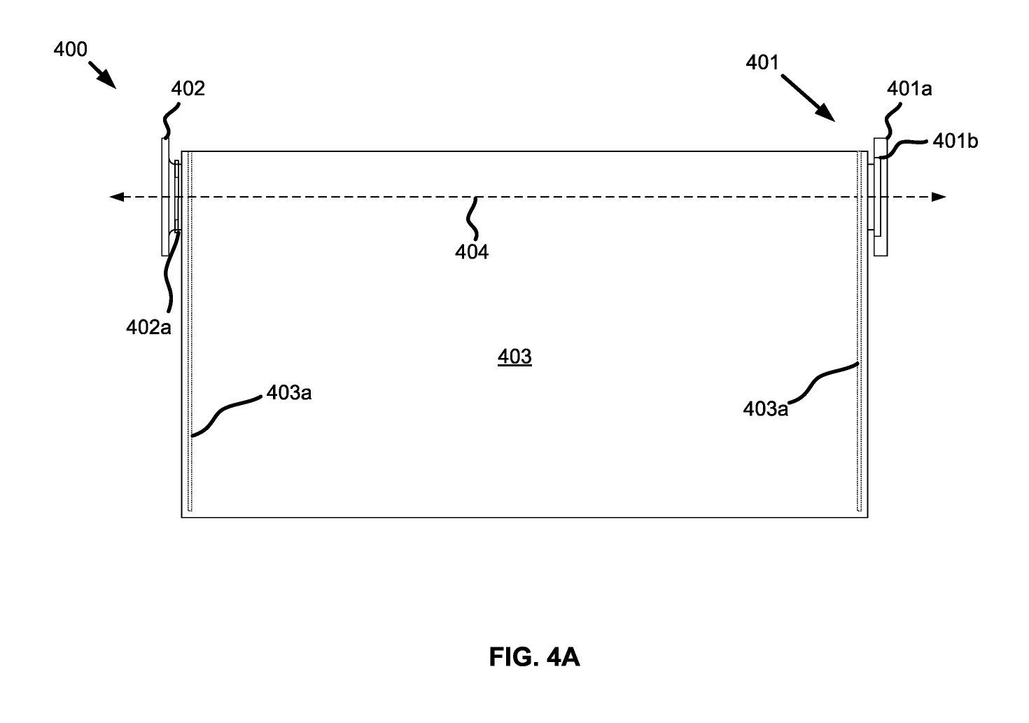

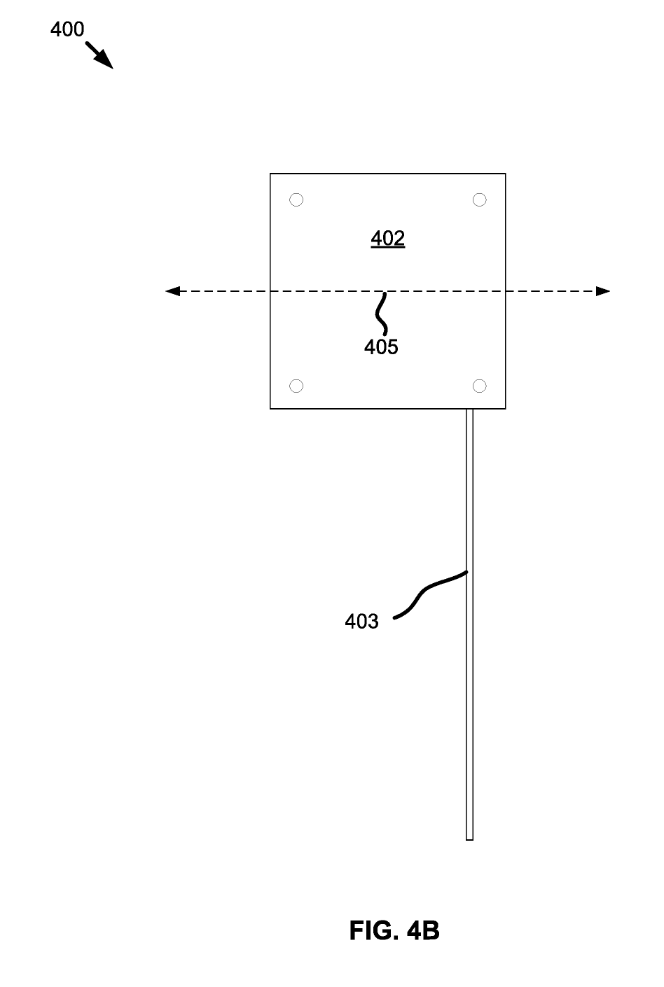

FIGS. 4A-B depict front and side views, respectively, of a roll-up window shade. The window shade 400 includes an extendable bracket 401 with a first segment 401a and a second segment 401b, a rotatable bracket 402 with a hinge 402a, a flexible panel 403 with flexible magnets 403a, a longitudinal axis 404, and a transverse axis 405. The hinge enables rotation along the transverse axis of a tube around which the flexible panel is wound, and causes extension of the second segment from the first segment, granting a user access to internal components of the tube. The magnets are glued to the panel and ensure proper alignment of the panel on the tube as the panel is wound onto the tube. Alternatively, the magnets may be stitched into the flexible panel and/or may be segmented. The magnet may be segmented according to the diameter of the tube and thickness of the magnets and flexible panel to ensure that magnet segments align as the flexible panel is wound onto the tube. For example, a linear distance along the flexible panel between the magnet segments may increase towards a bottom edge (e.g. the edge 403b) of the panel.

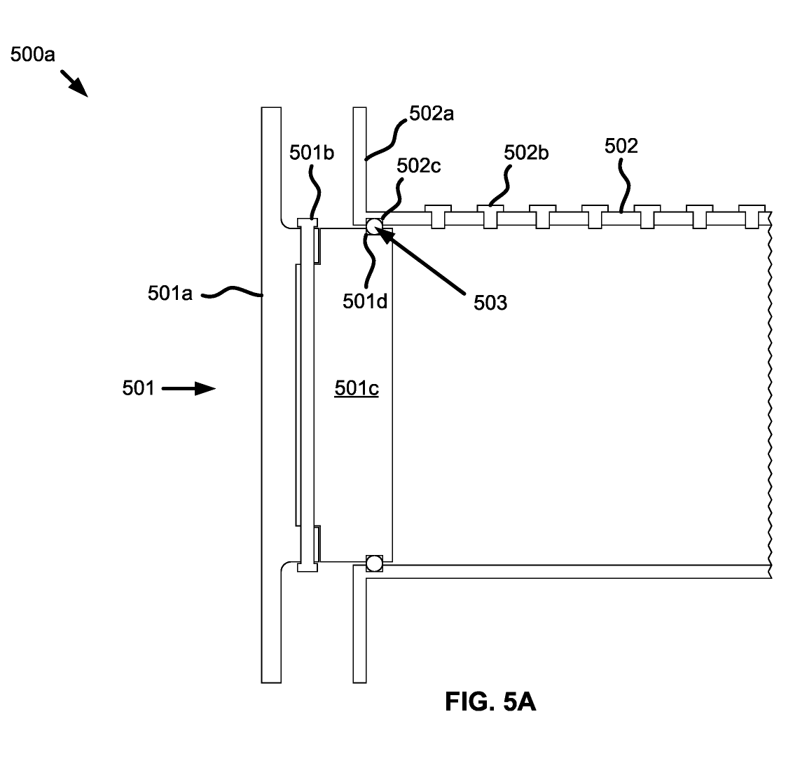

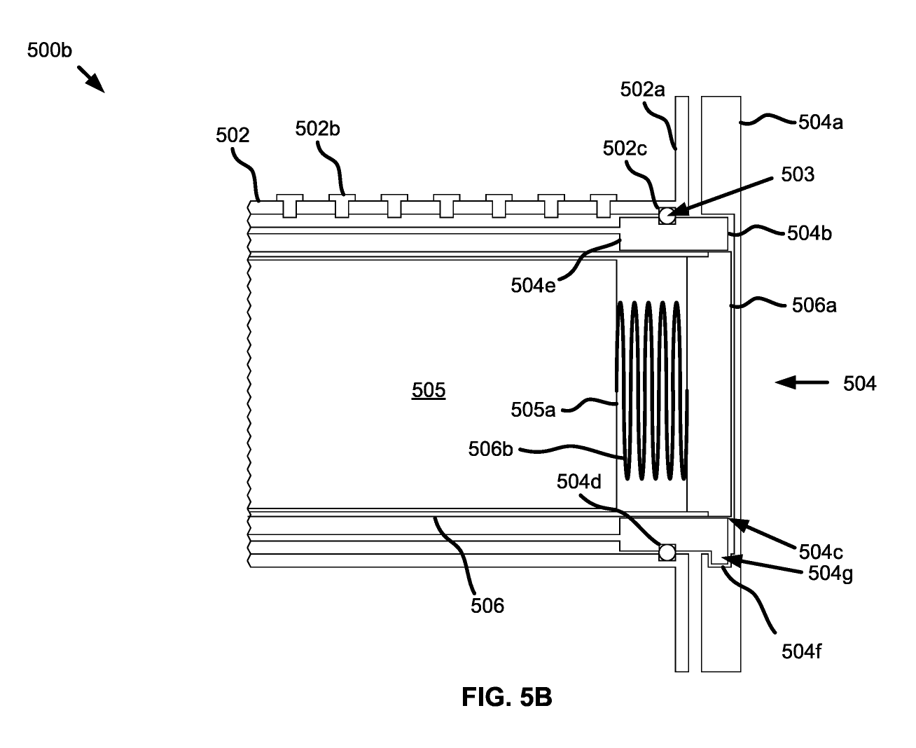

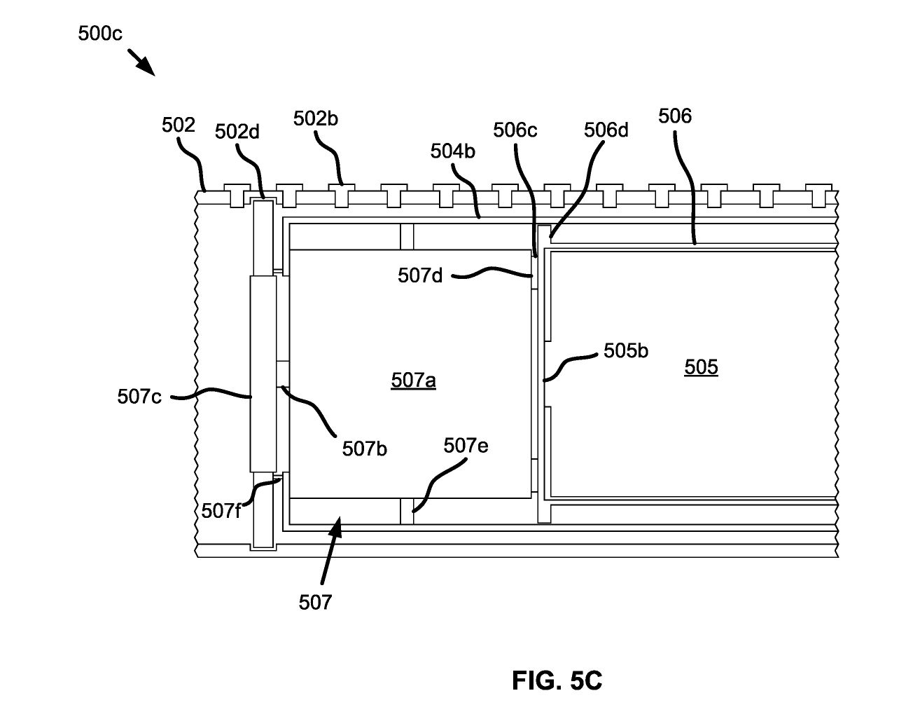

FIGS. 5A-C depict cross-sectional portions of a roll-up window shade sub-divided and zoomed-in to show detail. The depicted embodiment does not depict a flexible panel, but one may be attached to the assembly as described herein. FIG. 5A depicts a first end 500a of the window shade. The first end includes a rotatable bracket 501 having a mounting portion 501a, a hinge 501b and a support portion 501c with groove 501d, a tube 502 with flange 502a, pins 502b and groove 502c, and bearings 503. The pins pass through the flexible panel (such as that described above and with regard to other figures) to secure the flexible panel to the tube. The flange allows for proper alignment of the flexible panel on the tube as the flexible panel is wound onto the tube. The bearings enable smooth longitudinal rotation of the tube. Though not depicted, the bearings may be disposed in a ring that secures the bearings. The tube may be comprised of a flexible material, such as PVC, that may allow the tube to flex as the bearings and support portion of the bracket are inserted into the tube. In some embodiments, the tube and the support portion may include transverse faces, each with a complementary mating shape that allows the tube to be connected to the support portion. The support portion may be rotatably coupled to the hinge to allow for longitudinal rotation of the support portion. Thus, as in the depicted embodiment, in some embodiments, the support portion remains stationary as the tube rotates, and in other embodiments the support portion rotates with the tube.

FIG. 5B depicts a second end 500b of the window shade. The second end includes the tube 502 with the flange 502a, pins 502b and the groove 502c, the bearings 503, an extendable bracket 504 that includes a first segment 504a, a second segment 504b, an opening 504c, a groove 504d, a stop 504e, a track 504f and a runner 504g, a battery 505 having an electrical contact 505a, and a battery sleeve 506 with a removable cap 506a and a spring 506b. The spring is conductive, and is electrically coupled to the battery and a motor (depicted in FIG. 5C). The sleeve may be removed from the second segment, which supports the sleeve and, in conjunction with the bearings, enables rotation of the tube. The stops prevent complete removal of the sleeve from the tube. The second segment remains fixed as the tube rotates. The second segment extends from the first segment similar to that described above regarding other FIGs. The runner moves in the track along the transverse axis, exposing the cap. The cap is removable to allow a user to access and/or exchange the battery. The spring helps the battery maintain electrical contact with the sleeve.

FIG. 5C depicts a middle section 500c of the window shade. The middle section includes the tube 502 with pins 502b and a toothed groove 502d, the second segment 504b, the battery 505 with another electrical contact 505b, the battery sleeve 506 with electrical contacts 506c and stops 506d, a motor 507 having a stator 507a, a rotor 507b, a transmission 507c, electrical contacts 507d and standoffs 507e. The battery sleeve completely encloses the battery, and includes conductive material, such as wiring, that electrically couples the battery to the motor. The stop on the sleeve prevents the sleeve from being completely removed from the tube. The motor is supported by the second segment via the standoffs. The rotor passes through the second segment and engages the transmission, which, in the depicted embodiment, includes a set of planetary gears. The planetary gears engage with the toothed groove to rotate the tube. Pins 507f connected to the gears and the second segment support the gears.

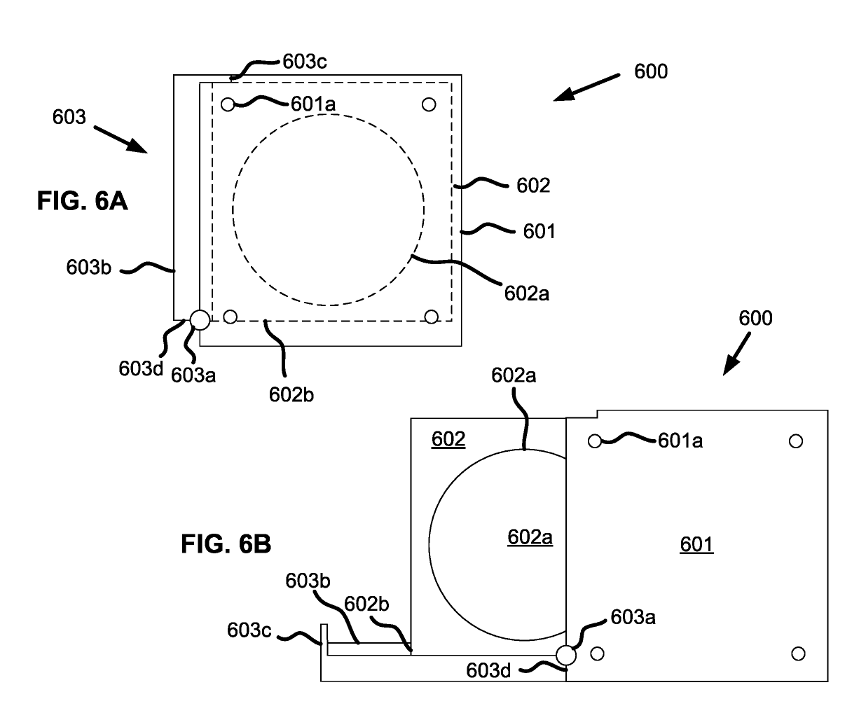

FIGS. 6A-B depict two views of an alternative embodiment of an extendable bracket that supports a tube of a roll-up window shade. The bracket 600 includes a first segment 601 with mounting openings 601a, a second segment 602 with an opening 602a and runners 602b, and a hinged track 603 with a pivot 603a, a track 603b, and a stop 603c. The hinged track is depicted in an “up” position in FIG. 6A. In the up position, the second segment is prevented from extending from the first segment by the hinged track. The hinged track may be held in place by, for example, a magnet disposed in the stop and a complementary magnet disposed in the first segment, by a clip, or by friction in the pivot, among other mechanisms. In FIG. 6B, the track is depicted in a “down” position, supported by a bottom edge 603d of the hinged track against the first segment. In the down position, the second segment may be transversely extended from the first segment. A user may access the internal components of the window shade through the opening as the second segment is extended from the first segment.

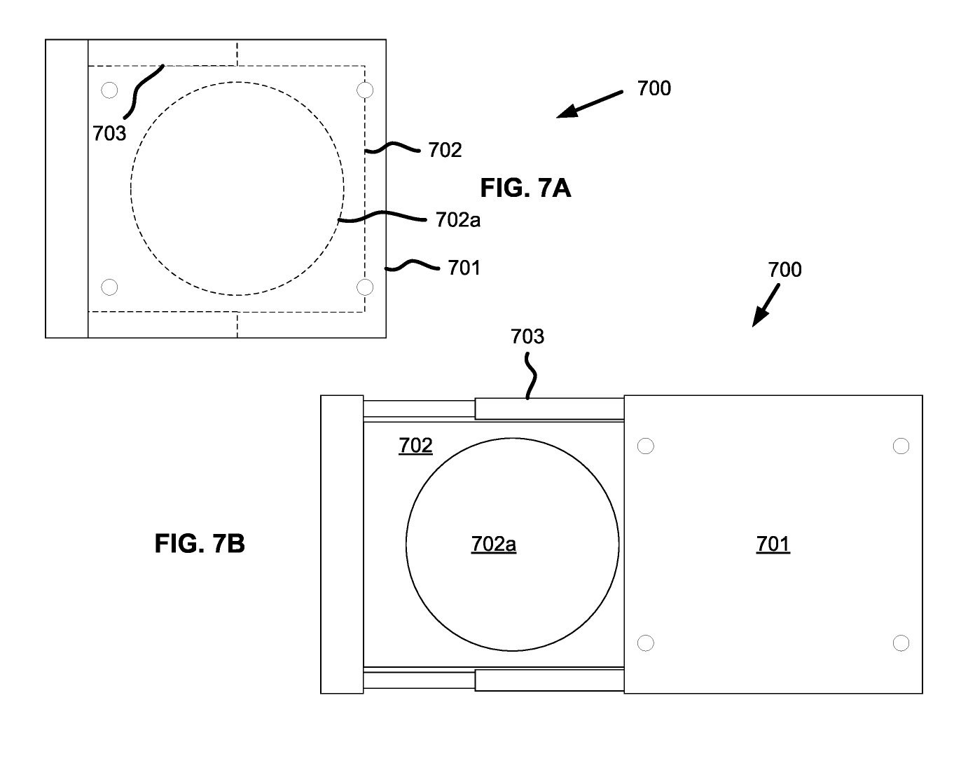

FIG. 7 depicts two views of another alternative embodiment of an extendable bracket that supports a tube of a roll-up window shade. The bracket 700 includes a first segment 701, a second segment 702 with an opening 702a, and telescoping rods 703. The telescoping rods enable extension of the second segment from the first segment, allowing a user to access the opening in the second segment. The telescoping rods also limit extension of the second segment. Limiting extension of the second segment from the first segment in any embodiment may prevent damage to an opposite, rotatable bracket that allows motion of the tube along a transverse axis.

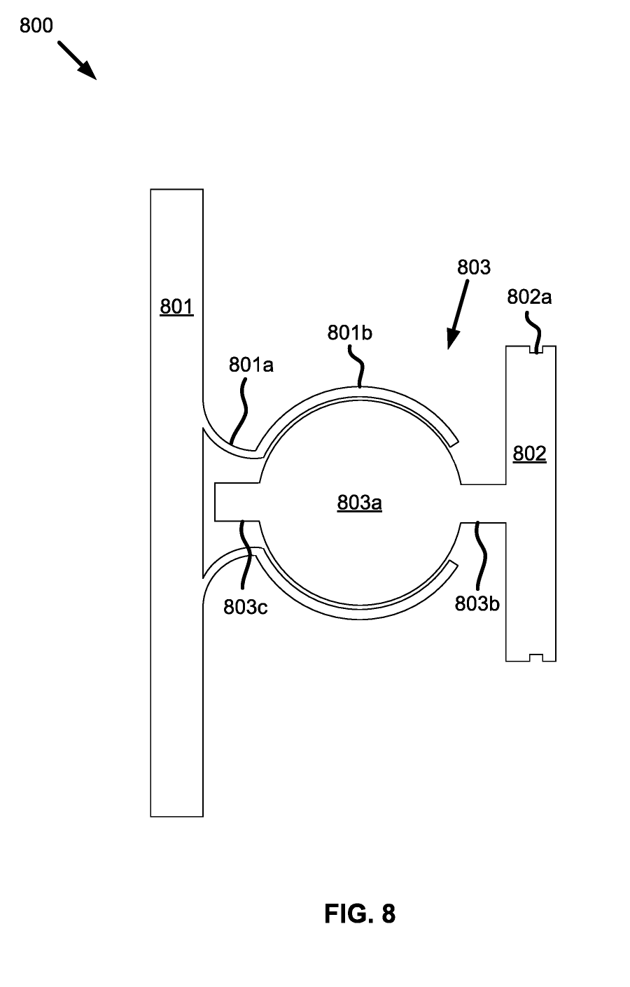

FIG. 8 depicts a cross-sectional view of an alternative embodiment of a rotatable bracket that supports a tube of a roll-up window shade. The bracket 800 includes a mounting segment 801 having a hollow arm 801a and a spherical housing 801b, a support segment 802 having a groove 802a, and a joint 803 having a ball 803a, a first arm 803b and a second arm 803c. The ball is disposed within the spherical housing. The first arm supports the support segment. The second arm prevents over-rotation of the joint by pressing against the interior of the hollow arm. This embodiment of the rotatable bracket may allow for rotation of the tube along multiple transverse axes, including a horizontal transverse axis, a vertical transverse axis, and/or combinations thereof. For example, it may be beneficial to rotate the tube along a transverse axis forming a downward 45-degree angle with the horizontal transverse axis, especially in embodiments where the tube is positioned overhead of a user.

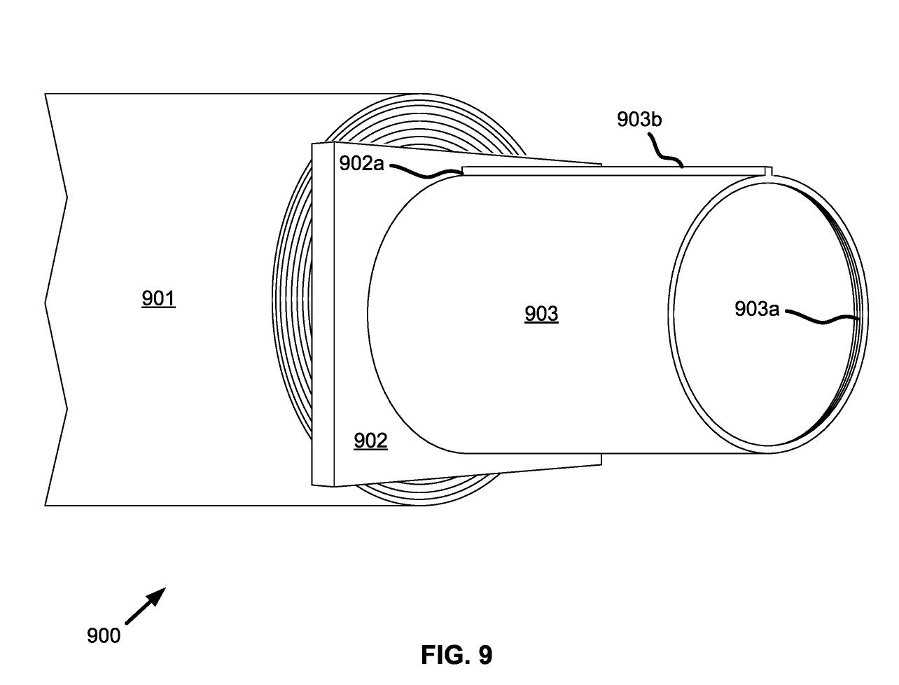

FIG. 9 depicts a battery sleeve partially removed from a tube of a roll-up window shade. The window shade 900 includes a flexible panel 901 wound around a tube, a second segment 902 of an extendable bracket (such as that described above regarding other FIGs.) having a track 902a, and a battery sleeve 903 with threading 903a and a runner 903b. As described previously, it may be problematic to change the batteries of a motorized roll-up window shade when the batteries are dead and the window shade is still rolled up. Thus, it may be useful to access the batteries through the end of the tube. FIG. 9 depicts how this may be done. The threading in the sleeve correspond to a cap that may be removed from the sleeve. The runner maintains alignment of the sleeve within the second segment, which may allow, in some embodiments, for proper electrical contact with a motor disposed in the tube. A user may extend the sleeve from the tube to allow for easier access to, and exchanging of, the batteries. In some embodiments, the sleeve may be completely removed from the tube. In other embodiments, it may be beneficial to retain the sleeve at least partially within the tube, and such embodiments may include stops, such as those described above regarding other FIGs.

We claim:

1. A motorized roll-up window shade, comprising:
a tube having a longitudinal axis perpendicular to a transverse axis;
a flexible panel connected to the tube that winds onto and off the tube;
an extendable bracket disposed inside and outside the tube, the extendable bracket comprising a first segment that affixes the extendable bracket to a mounting surface and a second segment connected to the tube and extendably connected to the first segment;
a rotatable bracket comprising an articulating joint and disposed at an opposite end of the tube from the extendable bracket, wherein the rotatable bracket rotates the tube along the transverse axis;
bearings disposed between the second segment and the tube and between the rotatable bracket and the tube enabling rotation of the tube along the longitudinal axis;
a motor disposed within the tube and supported by the extendable bracket;
one or more batteries disposed within the tube and supported by the extendable bracket,
wherein the extendable bracket comprises an opening through which the batteries may be accessed.

2. The motorized roll-up window shade of claim 1, wherein the extendable bracket comprises a securing mechanism that prevents motion of the second segment with respect to the first segment.

3. The motorized roll-up window shade of claim 1, wherein the second segment is connected to first segment by a telescoping rod.

4. The motorized roll-up window shade of claim 1, wherein the second segment is connected to first segment by a telescoping rod, and wherein the telescoping rod limits a range of rotation of the tube along the transverse axis.

5. The motorized roll-up window shade of claim 1, wherein the first segment comprises a track, and wherein the second segment comprises one or more runners corresponding to the track.

6. The motorized roll-up window shade of claim 1, wherein the first segment comprises a track, wherein the second segment comprises runners corresponding to the track, and wherein the track comprises a hinge, wherein the track folds out to allow the second segment to move along the track, and wherein the track folds back to prevent motion of the second segment with respect to the first segment.

7. The motorized roll-up window shade of claim 1, wherein the first segment comprises a track, wherein the second segment comprises runners corresponding to the track, and wherein the track aligns parallel to transverse axis.

8. The motorized roll-up window shade of claim 1, wherein the first segment comprises a track, wherein the second segment comprises runners corresponding to the track, and wherein the track comprises a stop that limits a range of motion of the tube along the transverse axis.

9. The motorized roll-up window shade of claim 1, wherein the articulating joint comprises a hinge.

10. The motorized roll-up window shade of claim 1, wherein the articulating joint comprises a barrel hinge having a longitudinal axis perpendicular to the tube's longitudinal and transverse axes.

11. The motorized roll-up window shade of claim 1, wherein the articulating joint is spherical and enables rotation of the tube along the tube's transverse axis and along an axis perpendicular to the tube's longitudinal and transverse axes.

12. The motorized roll-up window shade of claim 1, wherein the articulating joint comprises a spherical segment disposed in a spherical housing, the spherical segment comprising a first arm extending from the spherical segment and connected to the tube, and a second arm, and wherein the spherical housing comprises an opening through which at least a part of the spherical segment and the first arm extends, and a hollow arm within which the second arm is disposed.

13. The motorized roll-up window shade of claim 1, further comprising a removable cap connected to the second segment and disposed over the opening, the batteries disposed between the cap and the motor.

14. The motorized roll-up window shade of claim 1, further comprising a removable sleeve that partially or completely encloses the batteries.

15. The motorized roll-up window shade of claim 1, further comprising a removable sleeve that partially or completely encloses the batteries, the sleeve comprising a runner and the second segment comprising a track corresponding to the runner.

16. The motorized roll-up window shade of claim 1, further comprising a removable sleeve that partially or completely encloses the batteries, the sleeve comprising a stop that prevents the sleeve from being completely removed from the tube.

17. The motorized roll-up window shade of claim 1, wherein the rotatable bracket comprises a mounting segment that mounts the rotatable bracket to a mounting surface, the mounting segment comprising a length equal to at least twice a diameter of the tube.

18. The motorized roll-up window shade of claim 1, the tube comprising a groove along an interior circumference of the tube, and the extendable bracket, the rotatable bracket, or both, comprising a groove along an exterior circumference, the bearings disposed in the interior circumference groove and the exterior circumference groove.

19. The motorized roll-up window shade of claim 1, the tube comprising one or more flanges at one or more ends of the tube, wherein the flanges align the flexible panel on the tube as the flexible panel is wound onto the tube.

20. The motorized roll-up window shade of claim 1, wherein the flexible panel comprises one or more magnets along one or more edges of the panel, wherein the magnets align the flexible panel as the flexible panel is wound onto the tube.
